(19) United States
(12) Patent Application Publication
(10) Pub. No.: US 2019/0379619 A1
(43) Pub. Date: Dec. 12, 2019

(54) METHOD FOR EXCHANGE OF MULTIMEDIA DATA AMONG MOBILE DEVICES VIA INSTANT MESSAGING

(71) Applicant: JLG GROUP S.R.L., Firenze (IT)

(72) Inventors: Jonathan PIERINI, Bagno A Ripoli (IT); Lorenzo TONELLI, Firenze (IT); Giovanni CUPELLI, Firenze (IT)

(21) Appl. No.: 16/480,235

(22) PCT Filed: Feb. 2, 2018
(86) PCT No.: PCT/IB2018/050661

§ 371 Date: Jul. 23, 2019

(30) Foreign Application Priority Data
Feb. 3, 2017 (IT) 102017000011928

(51) Int. Cl. H04L 12/58; G06F 16/40; H04N 21/4788; H04L 9/06

(52) U.S. Cl. CPC H04L 51/10; G06F 16/40; H04L 2209/38; H04N 21/4788; H04L 9/0637; H04L 51/046

(57) ABSTRACT

Method to transmit multimedia data in instant messaging telematic services to and from devices, wherein in a same conversation between a calling device (Tc) and at least one receiving device (Tr), a resident program (App) is provided which, if executed, determines in the calling device the transmission to the receiving device (Tr) of all entered and/or deleted text data during a conversation through the text interface (TXT), and in the receiving device the representation in the video interface (SCR) of the device of said entered and/or deleted text and/or multimedia data with a delay of a few seconds, for example 2-3 seconds, with respect to the time of data entry in the calling device.

### FIELD OF THE INVENTION

The invention relates to a method to transmit multimedia data in an instant messaging telematic service, i.e. “chat”, to and from mobile devices, such as smartphones or tablets with access to a telecommunication and data transmission network, for example the Internet.

The term “data” is used to encompass generally multimedia data, for example data connected to text messages, and/or to graphic content such as picture, video and/or audio content.

### STATE OF THE ART

Instant messaging platforms have been known for long time, enabling the interactive exchange of data, messages and/or multimedia content over the Internet between two users or among participants to discussions in a “chat” of groups of users, equipped with portable devices such as smartphones or tablets with at least an interface for typing text, an audio interface for capturing sounds, a graphic interface for capturing pictures or videos and an interface for displaying texts and/or graphic content and/or to play audio content received by another participant.

In the known systems, the exchange of text and graphic/audio content, even associated to a text, is made possible to the participants of the chat.

Typically, a user is allowed to type text on his own device, possibly attach to the text a graphic or audio content, and send the text and relevant attachments to one or more participants.

The operations of sending, receiving, and the interactively exchange among participants are managed locally by a suitable software or “App” installed on the users' devices and by a remote server dedicated to the management of the messaging service, which identifies the users with the relevant “App” and regulates data traffic among participants.

However, the known types of messaging systems are not yet able to represent in a sufficiently accurate manner the actual context in which the conversation takes place, in terms of actual behaviour and status of the connected users.

Therefore, there is still the need for an instant messaging tool which is able to faithfully transfer, in terms of timing and content, the result of the communication among the relevant users.

### OBJECT OF THE INVENTION

A first object of the present invention is therefore to propose a messaging system which is able to transfer among the users a faithful representation of the communication initiated by each user, in terms of textual, audio and multimedia content.

### SUMMARY OF THE INVENTION

These and further objects have been achieved with an apparatus provided with an instant messaging system according to one or more of the appended claims.

A first advantage of the invention is represented by the fact that the users can view on their own devices a faithful representation, in terms of timing and content, of the information actually entered on other users' devices, even if possibly removed in a second step.

A second advantage is that this system gives users the possibility to write to each other simultaneously, without any limits.

### LIST OF THE DRAWINGS

These and other advantages will be better understood by anyone skilled in the art thanks to the following specification and the accompanying drawings, given as a non-limiting example, wherein:

FIG. 1 shows a general diagram of an apparatus for managing an instant messaging system among a number of users.

FIG. 2 shows schematically a diagram of an apparatus for the implementation of the inventive method.

FIG. 2a shows schematically a diagram of a mobile device for the implementation of the inventive method.

FIG. 2b shows schematically a preferred embodiment of the invention;

FIG. 3 shows an exemplary configuration of an interface of a mobile device on which the inventive method is in operation;

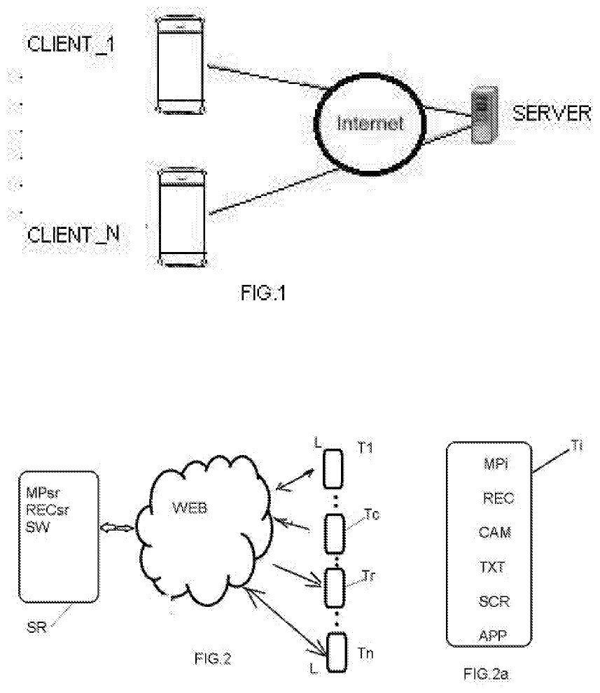

### DETAILED DESCRIPTION

With reference to the drawings, a method for the transmission of multimedia data in instant messaging telematic services to and from mobile devices via an apparatus will be now described, comprising:
a plurality of telecommunication mobile devices (T1-n) accessible to corresponding users and each provided with:
   a connection (L) to a telecommunication network (WEB) for the exchange of multimedia content among devices (Ti) participating to the same instant conversation,
   a local electronic unit (MPi) configured for the management of multimedia data,
   a local memory (REC) to store, at least temporarily, entered and/or deleted multimedia data,
   a camera (CAM) for the direct capture of pictures and videos, operatively connected to said management unit,
   a text interface (TXT) allowing the user to input and/or delete text data,
   a multimedia interface (SCR) to allow the user to enter, delete, and/or represent multimedia data within the same visible space associated to an ongoing conversation, for example, a touch screen,
   a local memory (REC) to store, at least temporarily, entered and/or deleted multimedia data and/or text, within a same instant conversation,
   a program for a local processor (App) resident in said memory, which if executed by the electronic unit determines via the interface (L) the reception and/or transmission of multimedia data from and/or to at least one further device,
a remote server unit (SR) connected to said network (WEB) and in communication with the devices (Ti) of the users participating to the conversation, the server unit being provided with:
   a remote electronic unit (MPsr) adapted to perform the exchange of multimedia data among the participating devices,
   a remote memory (RECsr) to record, at least temporarily, the multimedia data exchanged among the devices,
   a program for a processor residing in said remote memory, which, when executed by the remote electronic unit, determines the exchange of multimedia data among two or more devices (Ti) of the users participating to a same conversation.

According to the invention, in a same conversation between a calling device (Tc) and at least one receiving device (Tr), said program for local processor (App), if executed by the local electronic unit, determines in the calling device:
the transmission to the receiving device (Tr) of all entered and/or deleted text data during a conversation via the text interface (TXT)
the transmission to the receiving device (Tr) of all multimedia data entered during a conversation, even in the absence of a final consent for the transmission,
the inhibition of the ability to correct and/or delete the multimedia data entered into the device,
the inhibition of the transmission of pre-existing multimedia data in the terminal with respect to the beginning time of the conversation, furthermore, it determines in the receiving device
the representation in the video interface (SCR) of the device of said entered and/or deleted text with a delay of a few seconds, for example 2-3 seconds, with respect to the time of data entry in the calling device,
the representation in the video interface (SCR) of the receiving device of said multimedia content simultaneously or with a delay of a few seconds, for example 2-3 seconds, with respect to the time of data entry in the calling device.

Advantageously, the method of the invention implements a semi-simultaneous writing, the executive process of which is based on the delay of a few seconds with respect to the action directly performed by the user writing and/or deleting on his telephone and/or keyboard.

With this solution, users will be allowed to see in a transparent and clear manner the typing of the message and its entire composition (writing/deleting), replacing those functions of the known conversation methods of the chats, which currently provide an encryption of typing replaced by dynamic dots or by alerts such as “is writing” to notify to the receiving user that another participant to the chat is composing a message.

The proposed method thus enhances the spoken (i.e. typed) word which is no longer retractable, in addition to the function of being able to acknowledge and see live or semi-live what a user is currently writing. The ability to see this in an unencrypted way thus involves a new telecommunication method in the field of simultaneous chats.

Furthermore, having the opportunity to see almost simultaneously what is happening, the user will be almost inevitably intrigued or “forced” to stay in the chat to see what happens with the advantage that, the action-sending-receiving-viewing steps being merged, the users are induced to be online much more often, much longer, with respect to all other chats currently available in the market, such as WhatsApp, Telegram, Messenger, WeChat, Instagram, Snapchat.

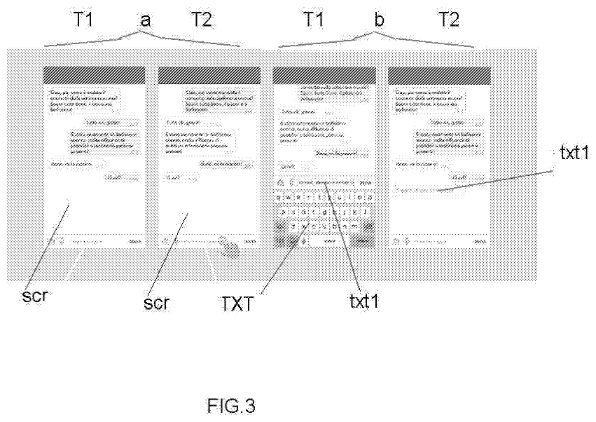

FIG. 3 shows schematically two consecutive moments (a, b) of a conversation between two users equipped with respective devices T1, T2, each provided with a video SCR and text TXT interface.

The example shows a first moment (a) in which users T1, T2 have exchanged some text messages which appear, in a per se conventional manner, on the respective SCR interfaces.

On the other hand, moment (b) represents the user T1 who is typing via the TXT interface a text txt1 which, according to the invention, also appears in the video interface of the receiving user T2.

In a preferred embodiment of the method, the multimedia interface (SCR) is a touch screen comprising an icon dedicated to the activation of an audio recording function and/or an icon dedicated to the activation of the camera for capturing pictures or videos, and wherein a long pressure of said icon within said visible space activates an audio recording and/or a picture or video capturing and their direct transmission in the absence of the final consent to the transmission and without any other possibility to correct and/or delete the recorded sound, as the latter will be automatically sent at the release of the respective dedicated icon.

Further preferably, the function of loading and sending audio content and/or pictures and videos uploaded from the device memory is inhibited.

In a further preferred embodiment of the method, the interface (SCR) is adapted to allow an editing board function of the content of recorded pictures or videos by writing and/or drawing by means of pressure on the screen, the changes to the video being able to be sent, changed and/or deleted by the calling user but still remaining visible to the receiving user.

According to the method, the program for a local processor (App) residing in said memory of the device may also include a “ghost” function that, if executed, makes the conversation with another designated user temporarily invisible and, in particular, makes the notifications between the two users in question and the information of the designated user temporarily invisible to the user exerting this function.

With this solution, all functions made temporarily invisible will be restored after a time interval pre-determined in an initial step where the user exerting that function is allowed to determine how many hours it will be active (max hours 4-8-12-24).

While enabling this function, it will be impossible for the user exerting it to receive, view, and/or send any message to the designated user.

Retrieving chat and information of the “ghosted” user before the deactivation of the function (to be assessed whether it will be automatically reactivated or if the user will be notified for cancellation or renewal of the function towards the user who has already been subjected to it). The user subject to the activation of the ghost function will be inhibited to write in the chat, and he will not be able to interact with the social content of the user who “ghosted” him, but he will still be able to see on his own profile all the current notifications and the contact information of the user exerting the “ghost” function.

The user subject to said “ghost” function will also receive a corresponding alert notification, possibly even at the end of the ghost function.

The program for local processor (App) resident in said memory of the device can also include an “offline” function which, when executed, inhibits the ability of the user to be contacted and/or to receive messages from any other user of the conversation.

The user exerting this function is therefore given the option not to be contacted and/or to receive messages by/from every user of the app (both included and not included in his/her contacts). The user will be offline and inactive in every set of the app (both chat and social) and will not be able to benefit from the functions of the app only after activating the “online” function.

The users who will try to contact someone exerting this function will be able to view his profile and relevant content, without being able to have any direct interaction with him. Further preferably, in a possible mode of performing a group chat, the user exerting the offline mode will not have any possibility to recover the messages sent from the other participants and not read during the time interval wherein the above mentioned function was active.

In this regard, the program (App) resident in said device memory, may include a “Group chat” function which, if executed, allows the user to select one or more users of the conversation enabled to said delayed representation of said text or multimedia data.

In the management of the group chat, for a smoother graphic management, it will be possible to provide a preference and/or priority list where the user can view the conversation only with the preferred user, in case that more than one member of the group chat are writing at same time.

The user will therefore fill in a list of preferred users where, in the event that different users of the chat are writing at the same time, he/she will only see the priority one. If the priority user wasn't writing, the second one would be viewed, then the third one (descending order) until the last user of the preference list would be viewed. On the other hand, if the users were writing in turn, the user currently writing in the conversation would be viewed.

In order to improve the usability of the user interface, the (App) residing in the device memory may include a graphic display function of the conversation which, if executed, allows to select among different graphic shapes of the message box inside the visible space of the content being exchanged with another user, for example selected from: square, cartoon bubble, heart, star, cloud; they are possibly customizable with board function or loaded from the device memory.

Advantageously, with this solution, a user will be able to upload and/or select a customizable form of the message box for each single chat.

In addition, size and colours of the edge of the message box, the background colour of the box message, the background of the space on the representation interface of the chat, colours and size of the font will be possibly customizable. All of this only refers to sent messages scenario, while as to the received ones it is necessary to set the same configuration or the same “graphic harmony” of the other user who has to accept the same changes and/or graphic conditions, otherwise the received messages will keep a traditional look as per the basic version and not the personalized one.

In case of particularly long single messages, for example more than a few tens of characters, for example, it is provided that the (App) can include a graphic display function of the conversation with users of the conversation which, if performed, at the achievement of a pre-determined number of characters in a single message, it creates a linked succession of container frames of the content of the conversation, in order to keep recognizable the single message of the conversation as a whole, but graphically well readable by the user even when the length of the text is greater than the pre-determined number of characters.

Again, in order to enhance the usability of the chat, the App may further include a dynamic graphic display function of the conversation which, if executed, allows to make the boxes inside the visible space of the content being exchanged with another user dynamic. Preferably, the dynamic function can be activated through a long pressure on the box, the boxes being movable in more than one icon/section corresponding to different actions of the user, such as: saving, deleting, forwarding, editing.

With this solution, the “message container” boxes will be even more dynamic, for example giving the possibility to the user to press on the boxes and change their mode into “vibrant” in order to be able to move them in the icons/sections corresponding to the different actions of the user, such as:
saving (the message is dragged on the “envelope” icon to create a copy of the text file in the “notes” of the phone)
deleting (the message is dragged into the “basket” icon and explodes or vaporizes)
forwarding (the message is dragged on an “contact list” icon where the user will be able to choose the recipient of the content)
board (the message is dragged on the board function where the user is allowed to edit the message with graphic functions and sets, and then to save it as “media” file)

The App may also include a “zoom” graphic display function of the conversation with the users of the conversation which, if executed, allows to zoom in the boxes containing the content of the conversation. In this case, the user will be given the ability to zoom in directly the chat screen to view better and in a more detailed manner the preview of media and text content without having to switch from the “save/forward/screenshot” function as commonly provided in the known simultaneous chat applications for the zoom of any content of the chat. If the user is not online simultaneously with the user who “is writing”, it is further provided a function of “timeline recording” of the received messages, which includes an animated recording of the composition of the received message (writing and/or deletion) which will be reviewed and reproduced by the receiving user, by pressing with the finger on the text of the received message.

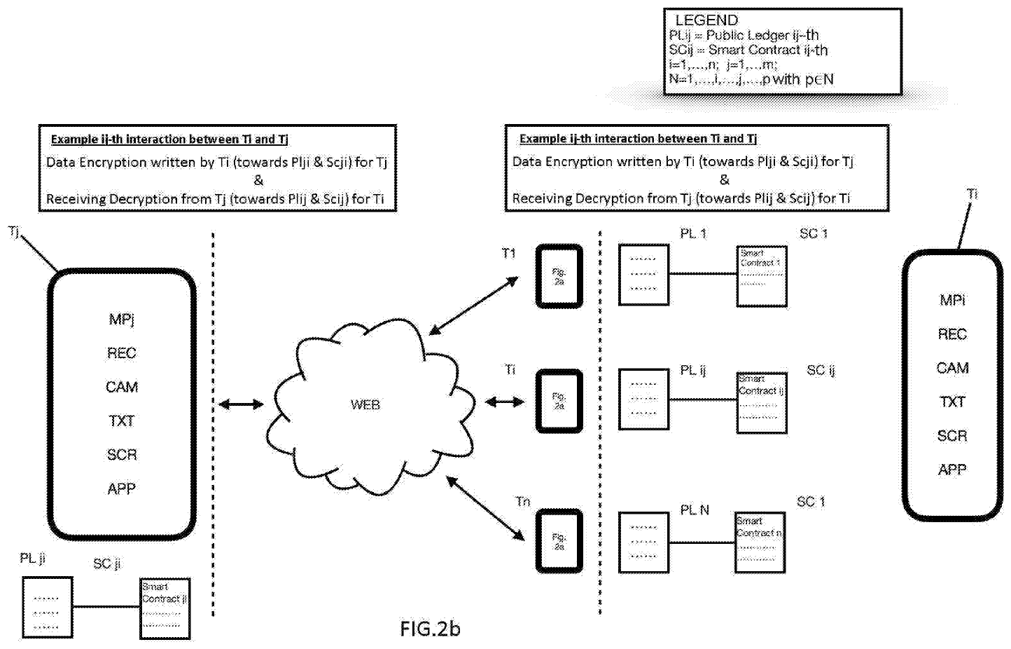

In a preferred embodiment shown schematically in FIG. 2b, the functions of the remote server unit (SR) may be performed by each of the terminals connected to said network (WEB) and participating in the conversation, in a “peer to peer” configuration. in which the terminals can act both as client and as server to the other terminals participating in the same conversation, and the conversation is managed with a blockchain technology for exchanging encrypted contents.

In this example, the local electronic unit (MPi) of the terminals is arranged for the management of multimedia data and in particular to perform the exchange of multimedia data between the participating terminals, while the local memory of the terminals (REC) is prepared for at least temporary recording of multimedia data of data entered and/or deleted, and is provided with the program (App) residing in said remote memory that, as seen above, if performed by the electronic unit determines through the interface (L) the reception and/or the transmission of multimedia data from and/or to at least one further terminal, or the exchange of multimedia data between two or more terminals (Ti) of users participating in the same conversation.

In this embodiment, the terminals can then function as servers when the content is sent (example: Ti writes) and from client at the time of reception (example: Tj receives).

According to the scheme of a blockchain technology, a database of the conversation history called generally “Public Ledger” automatically records the PLij-th transaction between Ti sending and Tj receiving, storing the content according to an encrypted authentication software protocol SCij (generally referred to as Smart Contract).

Vice versa, if Tj were sending and Ti receiving, Tj becomes server and Ti becomes client with relative Tji-th transaction and Smart Contract SCji.

The present invention has been described according to preferred embodiments; however, equivalent variants can be conceived without departing from the scope of the present invention.

1. Method to transmit multimedia data in instant messaging telematic services to and from mobile devices via an apparatus comprising
a plurality of telecommunication mobile devices (T1-n) accessible to corresponding users and each provided with:
a connection (L) to a telecommunication network (WEB) for the exchange of multimedia content among devices (Ti) participating to the same instant conversation,
a local electronic unit (MPi) configured for the management of multimedia data,
a camera (CAM) for the direct capture of pictures and videos, operatively connected to said management unit,
a text interface (TXT) allowing the user to input and/or delete text data,
a multimedia interface (SCR) to allow the user to enter, delete, and/or represent multimedia data within the same visible space associated to an ongoing conversation, for example, a touch screen,
a local memory (REC) to store, at least temporarily, entered and/or deleted multimedia data and/or text, within a same instant conversation,
a program for a local processor (App) resident in said memory, which if executed by the electronic unit determines via the interface (L) the reception and/or transmission of multimedia data from and/or to at least one further device,
a server unit connected to said network (WEB) and in communication with the devices (Ti) of the users participating to the conversation, the server unit being provided with:
an electronic unit adapted to perform the exchange of multimedia data among the participating devices,
a memory to register, at least temporarily, the multimedia data exchanged among the devices,
a program for a processor resident in said remote memory, which, when executed by the electronic unit, determines the exchange of multimedia data among two or more devices (Ti) of the users participating to a same conversation.
characterized in that in a same conversation between a calling device (Tc) and at least one receiving device (Tr), said program for local processor (App), if executed by the local electronic unit, determines in the calling device:
the transmission to the receiving device (Tr) of all entered and/or deleted textual data during a conversation via the text interface (TXT)
the transmission to the receiving device (Tr) of all multimedia data entered during a conversation, even in the absence of a final consent for the transmission,
the inhibition of the ability to correct and/or delete the multimedia data entered into the device,
the inhibition of the transmission of pre-existing multimedia data in the terminal with respect to the beginning time of the conversation,
furthermore, it determines in the receiving device
the representation in the video interface (SCR) of the device of said entered and/or deleted text with a delay of a few seconds, for example 2-3 seconds, with respect to the time of data entry in the calling device,
the representation in the video interface (SCR) of the receiving device of said multimedia content simultaneously or with a delay of a few seconds, for example 2-3 seconds, with respect to the time of data entry in the calling device.

2. Method according to claim 1, wherein said server unit consists of one of said terminals (Ti) acting as a server at the time of sending the content to a second terminal (Tj) acting as a client at the time of receiving, and wherein said conversation between the calling (Ti) and receiving (Tj) terminals is a transaction (PLiJ) of content encrypted by a blockchain technology, including an automatic registration of the PLij-th transaction in a conversation history database according to an encrypted authentication software protocol (SCij).

3. Method according to claim 1 wherein said server unit is a server remote unit (SR) connected to said network (WEB) and, via the WEB, in communication with the devices (Ti) of the users participating to the conversation, the server unit being provided with:
a remote electronic unit (MPsr) adapted to perform the exchange of multimedia data among the participating devices,
a remote memory (RECsr) to record, at least temporarily, the multimedia data exchanged among the devices,
a program for a processor (SW) residing in said remote memory, which, when executed by the remote electronic unit, determines the exchange of multimedia data among two or more devices (Ti) of the users participating to a same conversation.

4. Method according to one the claims 1-3, wherein the multimedia interface (SCR) is a touch screen comprising an icon dedicated to the activation of an audio recording function, and wherein a long pressure of said icon within said visible space activates an audio recording and its direct transmission in the absence of the final consent to the transmission and without any other possibility to correct and/or delete the recorded audio, as the latter will be automatically sent at the release of the respective icon dedicated to the activation of the audio recording function.

5. Method according to claim 4, wherein the function of uploading and sending audio content uploaded from the device memory is inhibited.

6. Method according to any of the preceding claims, wherein the multimedia interface (SCR) is a touch screen comprising an icon dedicated to the activation of the camera for capturing pictures and videos, and wherein a long pressure of said icon within said icon dedicated to the camera within said space activates a picture or video capturing and their direct transmission in the absence of the final consent to the transmission and without any other possibility to correct and/or delete the picture or video content, as the latter will be automatically sent at the release of the icon dedicated to the camera.

7. Method according to claim 5, wherein the function of uploading and sending picture or video content uploaded from the device memory is inhibited.

8. Method according to claim 6 or 7, wherein said interface (SCR) is adapted to allow an editing board function of the content of recorded pictures or videos by writing and/or drawing by means of pressure on the screen, the changes to the video being able to be sent, changed and/or deleted by the calling user but still remaining visible to the receiving user.

9. Method according to any of the preceding claims, wherein said program for local processor (App) residing in said memory of the device also includes a “ghost” function that, if executed, makes the conversation with another designated user temporarily invisible and, in particular, makes the notifications between the two parties in question and the information of the designated user temporarily invisible to the user exerting this function.

10. Method according to claim 9, wherein the temporarily invisible functions are reset after a time interval pre-established by the calling user.

11. Method according to any of the preceding claims, wherein said program for local processor (App) residing in said memory of the device also includes an “offline” function which, when executed, inhibits the ability of the user to be contacted and/or to receive messages from any other user of the conversation.

12. Method according to one of the preceding claims, wherein said program for local processor (App) resident in said device memory, includes a “Group chat” function which, if executed, allows the user to select one or more users of the conversation enabled to said delayed representation of said text or multimedia data.

13. Method according to any of the preceding claims, wherein said program for local processor (App) resident in said device memory includes a graphic display function of the conversation with the users which, if executed, allows to select among different graphic shapes of the message box inside the visible space of the content being exchanged with another user, selected from square, cartoon bubble, heart, star, cloud, possibly customizable with board function or loaded from the device memory.

14. Method according to any of the preceding claims, wherein said program for local processor (App) residing in said device memory includes a graphic display function of the conversation with users of the conversation which, if performed, at the achievement of a pre-determined number of characters in a single message, creates a linked succession of container frames of the content of the conversation, in order to keep recognizable the single message of the conversation as a whole, but graphically well readable by the user even when the length of the text is greater than said pre-determined number of characters.

15. Method according to any of the preceding claims, wherein said program for local processor (App) resident in said device memory includes a dynamic graphic display function of the conversation which, if executed, allows to make the boxes inside the visible space of the content being exchanged with another user dynamic,
said dynamic function being activated through a long pressure on the box,
said boxes being able to be moved in multiple icons/sections corresponding to various actions which can be performed by the user such as: saving, deleting, forwarding, editing.

16. Method according to any of the preceding claims, wherein said program for local processor (App) residing in said device memory includes a “zoom” graphic display function of the conversation which, if executed, allows to zoom in the boxes containing the content of the conversation.

17. Method according to any of the preceding claims, wherein said program for local processor (App) residing in said device memory includes a recording function of the conversation with the users of the conversation executable when the user is not online simultaneously with a calling user and, if executed, performs an animated recording of the composition of the received message (writing and/or deletion), which can be reviewed and reproduced by pressing with the finger on the text box of the received message.
